(19) United States
(12) Patent Application Publication
(10) Pub. No.: US 2007/0037567 A1
(43) Pub. Date: Feb. 15, 2007

(54) Information transmission method and apparatus

(76) Inventors: Gary Steven Ungless, Papworth Everard (GB); Tom Evans, Papworth Everard (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/501,295

(22) Filed: Aug. 9, 2006

(30) Foreign Application Priority Data
Aug. 10, 2005 (GB) 0516470.2

(51) Int. Cl. H04Q 7/20

(52) U.S. Cl. 455/422.1; 340/10.33; 705/15

(57) ABSTRACT

A method and an apparatus are provided for transmitting information between a monitor and a remote computer. The monitor comprises a sensor coupled to a memory for logging data output by the sensor over time. The information transmission method includes the steps of interfacing the monitor to a base station for transmitting the information between the monitor and the base station, and transmitting the information between the base station and the remote computer by means of a text message or pager message. In this way, information can be transmitted in both directions, either from the monitor to the remote computer or from the remote computer to the monitor.

The invention relates to an information transmission method and apparatus, and in particular to a method and an apparatus for transmitting information between a data-logging monitor and a remote computer.

### BACKGROUND OF THE INVENTION

Monitors for a wide variety of data-logging applications are known. Such a monitor typically comprises a sensor for sensing a parameter that varies over time and a memory for storing, or logging, an output of the sensor. The monitor usually comprises a processor that is programmed to control the data-logging procedure, for example by ensuring that data is logged at predetermined time intervals or by filtering or otherwise processing the sensor output to convert it into a suitable form for storage in the memory. Such a monitor may advantageously be a self-contained unit and so require a power source. This is typically a rechargeable or non-rechargeable battery, or some other self-contained power source such as a photo-voltaic power supply.

In many applications there are clear advantages in designing a monitor that is self-contained and can operate autonomously to log or collect data over a period of time. Such a monitor may be inexpensive to install and operate, and avoid any need for wired connections to a mains power supply or to a computer for data analysis. The monitor can then be portable, for example for use in a vehicle or as a medical or physical fitness monitor to be carried or worn by a person or animal. Examples may include monitors for pollution monitoring, environmental monitoring, chemical monitoring or temperature monitoring, medical monitors such as blood-sugar monitors, sleep monitors, electrocardiographic (ECG) monitors and movement monitors, and fitness monitors such as pedometers and energy-expenditure monitors.

A problem arises in the use of a self-contained, or autonomous, data-logging monitor because of the need to retrieve the stored data and process or display it, which can usually most conveniently be done at a computer remote from the monitor. In addition, a system for data-logging, such as a pollution-monitoring system, may comprise a number of different monitors installed at different locations, and it would be desirable to be able to retrieve stored data from such a plurality of monitors to a single remote computer.

### BRIEF SUMMARY OF INVENTION

The invention provides in its various aspects a method and an apparatus for transmitting information between a monitor and a remote computer, and a method for encoding a text message, as defined in the appended independent claims, to which reference should now be made. Preferred or advantageous features of the invention are set out in dependent subclaims.

In a preferred embodiment, the invention thus provides a method for transmitting information between a monitor and a remote computer by means of a base station. The monitor comprises a sensor coupled to a memory for storing data output by the sensor over time. The base station is preferably a portable or hand-held device, such as a mobile telephone or a personal digital assistant (PDA) or a portable computer with mobile telephone functionality, or at least with text-messaging functionality. The base station may alternatively be a bespoke device with mobile telephone (or text-messaging) functionality, designed for communications with the monitor and the remote computer. Information is transmitted between the monitor and the remote computer by means of an interface between the monitor and the base station, and by transmitting the information between the base station and the remote computer by means of a text message carried on a mobile telephone network.

The monitor may be interfaced to the base station in any convenient manner, for example by means of a direct electrical connection such as a connecting cable, for example a USB cable. But the interface is preferably a wireless interface, such as a Bluetooth (RTM) or Zigbee (RTM) radio link, or an infra-red (IR) link, or an inductive link.

Thus, in a preferred embodiment, information can be transmitted between the monitor and the remote computer by means of a Bluetooth or Zigbee or other wireless link between the monitor and the base station, and by the transmission of one or more text messages between the base station and the remote computer. In this way, in one embodiment, a user carrying a portable base station may approach a monitor and set up an interface between the base station and the monitor in order to enable the transmission of information between the monitor and the remote computer. Advantageously, any such information may include information identifying the monitor so that the same base station can be used to enable information transmission between a plurality of monitors and a single remote computer.

In a further embodiment, a wireless interface may be used to couple or connect the monitor with the base station and to download and/or upload data while a pair of metal contacts or other wired connection is also provided for recharging a rechargeable battery within the monitor. This embodiment may provide the following advantage. A wireless interface may be desirable to allow information transfer without direct contact between the monitor and the base station but typically requires more power than a wired interface or an interface using direct electrical connection. In such a wireless device rechargeable batteries may therefore be more convenient than non-rechargeable batteries.

In an alternative embodiment, a wireless interface may be implemented in the form of an inductive link between the monitor unit and the base station. Power for information transfer across this interface may be derived from the base station and therefore require little or no energy consumption from the monitor's battery.

An inductive link may also be used to recharge the monitor's battery.

The monitor may advantageously be a self-contained unit comprising a sensor and a memory as described above, a monitor interface and a controlling monitor processor, all contained in a housing.

The base station may advantageously comprise a base-station processor coupled to a display, a user interface, such as a keypad, and first and second base-station interfaces, all mounted in a housing.

The first base-station interface is designed to couple to or communicate with the monitor interface. As described above, the interface may be wired or wireless and may advantageously permit both data transfer and, if the monitor is fitted with a rechargeable battery, power transfer to recharge the battery.

The base-station housing may comprise a portion which is shaped to receive a portion of the monitor housing to enable docking and completion of the interface, or the monitor and the base station housings may be provided with sockets for connection with an electrical lead, if the interface requires direct electrical contact.

The hand-held base station may be a purpose-built, or bespoke, unit or it may be implemented by suitably programming a portable device such as a mobile phone or a personal digital assistant (PDA). If a mobile phone or PDA is used then the monitor would need to dock, or interface, with this form of base station using whatever interface capability the mobile phone or PDA has, such as a wireless Bluetooth or infra-red interface, or a wired interface using a USB port or the like.

Advantageously, the remote computer may be coupled to a network, such as the Internet. In this case, text messages or pager messages may be transmitted between the base station and a corresponding text-message or pager-message service, or server, accessible on the network and can thus be accessed by the remote computer.

Preferably, information may be transmitted between the monitor and the remote computer in either direction. For example, information transmitted from the monitor to the remote computer may comprise data logged by the monitor, which may be transmitted in processed or unprocessed form. Information transmitted from the remote computer to the monitor may include monitor set-up information or a request for the monitor to download logged data.

In principle, any processing of the data for transmission and the creation and encoding or decoding of text messages may be handled at any point in the system, that is at the monitor, the base station or the remote computer. However, the following embodiments may present particular advantages.

In one embodiment, after an interface is created between the monitor and the base station, the monitor reads a telephone number for addressing the text message from a memory of the base station, creates the text message incorporating the information for transmission, and controls the base station to transmit the text message. The telephone number may, for example, be stored at a predetermined location in a telephone book of the base station. In other embodiments, however, the telephone number may be stored at any suitable predetermined location in a memory of the base station or the monitor.

In an alternative embodiment, after an interface between the monitor and the base station has been set up, any information for transmission to the remote computer is downloaded from the monitor to the base station. The base station then creates the text message incorporating the information for transmission, reads a telephone number for addressing the text message from its own memory, and transmits the text message. Again, the telephone number may advantageously be stored at a predetermined location in a telephone book of the base station. In this embodiment the information in the text message may not be in the same form as the information downloaded from the monitor; that is, the base station may process the downloaded information for transmission in the text message.

In these two embodiments, the same text message may ultimately be transmitted to the remote computer but the control of the text message creation and transmission is differently handled. Implementation of such alternative embodiments may depend on the nature of the interface between the monitor and the base station. For example, if a Bluetooth interface is used the monitor may effectively control the base station to transmit the text message.

In its various aspects, the invention envisages controlling the timing and/or frequency of information transmission between the monitor and the remote computer in a variety of ways. This may depend, for example, on the application of the monitor.

Since information is transmitted between the base station and the remote computer by means of text messages, and the capacity of each text message is limited, the information transmission cannot be continuous. Therefore, it is desirable to be able to control the timing of information transmission. In one embodiment, the monitor or the base station may comprise a user interface so that, on receipt of a user input, a text message may be created for transmission to the remote computer. Alternatively, the monitor and/or the base station may attempt to create a text message for transmission at predetermined times or predetermined time intervals. In a further alternative, the monitor and/or the base station may create a text message for transmission whenever an interface between them is newly set up. In some applications the monitor may be programmed so that information transmission is additionally, or alternatively, triggered in response to an output of the monitor's sensor; for example, information transmission may be triggered by the detection of a predetermined pattern or event in the sensor output or by the sensor output crossing a predetermined threshold.

It can be seen that it may not always be possible to create and transmit a text message. For example, if a monitor comprises a user interface, such as a push button, then when the button is pressed to indicate that a text message should be created for transmission, then no such action can be taken at that time unless the monitor is interfaced to the base station or, for a wireless interface, unless the base station is sufficiently close to the monitor to allow an interface to be set up. Similarly, if the monitor is programmed to initiate the creation of a text message for transmission at predetermined times or at predetermined time intervals or in response to a predetermined sensor output, it cannot do so unless it is interfaced to the base station, or the base station is within range, at the time when the text message is to be created. In such an embodiment, the monitor and/or the base station may be suitably programmed to create a text message for transmission at a first available opportunity to interface the monitor and the base station after expiry of a predetermined time interval or after a predetermined time.

If such a delay arises in creating a text message for downloading logged data from the monitor to the remote computer, the monitor may nevertheless continue to log data in its own memory, until that memory is exhausted.

The likelihood of such delays arising may depend on the application of the sensor. For example, if information (logged data) is to be retrieved from a plurality of pollution monitors at different sites by a user visiting those sites with a portable base station, such as a mobile telephone, then a monitor programmed to download information to a base station at predetermined times may often fail to do so because it is unlikely that the base station will be within range to form an interface at the predetermined times. In such an embodiment, it may be preferable for a user input to the monitor or the base station to initiate information transfer and the transmission of a text message to the remote computer.

In an alternative embodiment, if a monitor is a medical monitor worn by a person, for example for monitoring blood-sugar level or physical activity, and the person usually carries a mobile telephone which functions as the base station, then if the monitor is programmed to download information to the base station at predetermined times, then it will usually be within range of the base station to form a wireless interface whenever a download is required. In this embodiment, programming the monitor or the base station to download logged data from the monitor at predetermined times would usually function satisfactorily. Such an embodiment may also be suitable for programming to download data in response to the sensor output, for example if the output crosses a predetermined threshold level or moves outside a predetermined range.

A further delay may arise after creation of a text message, namely in the transmission of the text message to the remote computer. For example, it may not be possible to transmit a text message at any particular time because of lack of mobile network coverage. In such a case, the text message may be stored and an attempt made to re-send it later. For example it may be placed in an out-box of the base station for transmission in the usual way when mobile network coverage is regained.

The foregoing discussion of the timing of information transmission concerns transmission of information from the monitor to the remote computer. Similar considerations may affect transmission in the opposite direction, from the remote computer to the monitor. Thus, the remote computer may create and transmit a text message to the base station when mobile network coverage permits. Transmission of the information from the base station to the monitor may then occur whenever the two are interfaced together, or in response to a user input to the base station and/or the monitor, as long as the base station and the monitor are interfaced to each other at that time or are sufficiently close to each other to allow a wireless interface to be set up.

In an alternative embodiment, a transfer of information between the monitor and the base station may be initiated whenever the two are interfaced together. For a wireless interface, this may occur whenever the monitor and the base station are brought sufficiently close to each other to detect each other's presence. This would maximise the opportunity to download logged data from the monitor to the base station, for example. A text message could then be created and sent to the remote computer whenever information is downloaded from the monitor to the base station. Alternatively, the information could be stored at the base station and text messages transmitted to the remote computer only at predetermined times or in response to user inputs or whenever the base station has received a predetermined volume of information from the monitor.

In a further embodiment, a text message containing logged data, in processed or unprocessed form, may be sent to the remote computer on receipt of, or as soon as possible after receipt of, a text message from the remote computer requesting this information.

Text Message Encoding

A text message conventionally comprises 140 8-bit bytes or 160 7-bit ASCII values. The message format can thus be either 8-bit or 7-bit characters. A problem arises, however, in that not all text-message transmission and reception devices can transmit or recognise all 8-bit or 7-bit characters. For example, some text-messaging services are for text only. Consequently, in a preferred embodiment of the invention, text messages are created in 7-bit format, to maximise the number of characters that can be sent in each message, but only text characters are used. Advantageously, this can be achieved by creating the information for transmission using a 6-bit character map, to represent 64 values, and transforming these 6-bit characters into a subset of the 7-bit character set, for example by using a look-up table. The subset of the 7-bit character set advantageously does not include any control characters, and preferably comprises only text characters.

Thus, stated in more general terms, this aspect of the invention provides a method and apparatus for creating a text message in 7-bit or 8-bit format but encoding the data for transmission in, for example, 6-bit format and using only a subset of the 7-bit or 8-bit character set to ensure reliability of transmission and reception.

Information for Transmission

In a preferred embodiment of the invention, a text message comprises a message header followed by the information for transmission. The header advantageously includes information identifying the monitor, so that a single remote computer can receive information from, and transmit information to, more than one monitor. Similarly, information identifying the monitor can be used by the base station so that a single base station can be used for communication with more than one monitor.

If the monitor is powered by a battery, a text message may include information as to the state of charge of the battery. This may advantageously be used to warn a user that the battery should be replaced or recharged.

Information for transmission from the base station to the remote computer typically includes data logged by the monitor, in processed or unprocessed form. A monitor may typically record data output by the sensor at a predetermined sensor output rate and may either store the raw data in its memory or filter or process the data in some way before storage. For example, a monitor may sample the sensor output at a predetermined rate and integrate or average these sample values over a predetermined sampling time, or epoch, storing the integrated or averaged values in its memory for downloading to the base station. Alternatively, data as sampled at the sensor output rate, which might be termed the raw data, may be stored in the monitor memory and downloaded to the base station, and the data may be processed by the base station before transmission to the remote computer. For example, the base station may filter the data, or may calculate averaged data values over predetermined sampling intervals, or epochs, before transmission of the processed data to the remote computer.

Alternatively, the raw data output by the sensor may be transmitted to the remote computer, although in some applications this may require excessive bandwidth.

In a typical embodiment, a monitor may be designed to be as simple as possible, in order to reduce costs and power consumption. Thus, for example, the monitor may have no display. In its simplest form, the base station may similarly have no capability to display logged data, in processed or unprocessed form, to a user. In such a case, all data display or analysis is carried out at the remote computer. Alternatively, however, the base station may have at least a limited capability to display and/or analyse logged data downloaded from the monitor. For example, if the base station is a suitably-programmed mobile telephone, PDA or mobile computer having a suitable display, then a user may able to analyse and display the logged data, in addition to transmitting the data to the remote computer.

As noted above, the remote computer can also transmit information to the monitor, by means of the base station. If the remote computer is in communication with more than one monitor, the information may be addressed to the correct monitor by means of a suitable monitor identification (monitor ID) in a message header. Information for transmission to a monitor typically comprises monitor set-up information, for example to control the sensor output rate or the sampling rate or sampling interval (epoch) length used by the monitor, or to control the times and/or frequency of transmission of logged data to the remote computer.

Following the discussion above, information sent by the remote computer as to the desired timing of reports of sampled data to the remote computer may be used by the base station and/or by the monitor, depending on which of these devices controls the timing of such data reports.

At the time when a text message is sent by the remote computer to the base station, in many applications it is likely that the base station may not be either interfaced to the monitor or close enough to the monitor to enable an interface to be set up. Consequently, such text messages may be stored in a memory of the base station for transmission to the monitor when the base station is next interfaced to the monitor. Such messages may be stored, for example, in a mail box of the base station or, in suitably encoded form, at a predetermined address in a telephone book of the base station. Alternatively, any other suitable memory location in the base station that can be accessed by the monitor may be used, the monitor being suitably programmed to search for the information at that location.

In addition to the transmission of set-up information from the remote computer, in a further embodiment of the invention set-up information may be input by a user to a suitable user interface, if present, of the base station or the monitor. For example, if the base station is a suitably-programmed device with a display and a keypad, then the base station may be programmed to prompt a user to input set-up information, which may be downloaded to the monitor as appropriate. For example, set-up information may be suitably encoded and stored in a memory of the base station, for example at a pre-determined address or location in the telephone book or in the out-box, for delivery to the monitor when the monitor is next interfaced to the base station.

When a monitor forms an interface with a base station, the monitor may advantageously be able to determine the type of base-station device to which it is interfaced and to download information in a format appropriate to the device. Thus, for example, if the monitor determines that it can interface to a mobile phone by a Bluetooth or Zigbee connection, it may connect with the mobile phone and download information to the mobile phone for onward transmission as a text message. Alternatively, if the monitor determines that the interfaced base station is suitably programmed, it may download processed or unprocessed logged data for further processing under the control of the base station, and for onward transmission of the downloaded information.

### BRIEF DESCRIPTION OF THE DRAWINGS

Specific embodiments of the invention will now be described by way of example, with reference to the accompanying drawings, in which:

FIG. 1 is a block diagram of an information transmission system according to a first embodiment of the invention;

FIG. 2 is a block diagram of the circuitry of a monitor embodying the invention;

FIG. 3 is a schematic diagram of a base station embodying the invention, in the form of a PDA; and

FIG. 4 illustrates the housing of the monitor of FIG. 2.

### DETAILED DISCLOSURE OF THE INVENTION

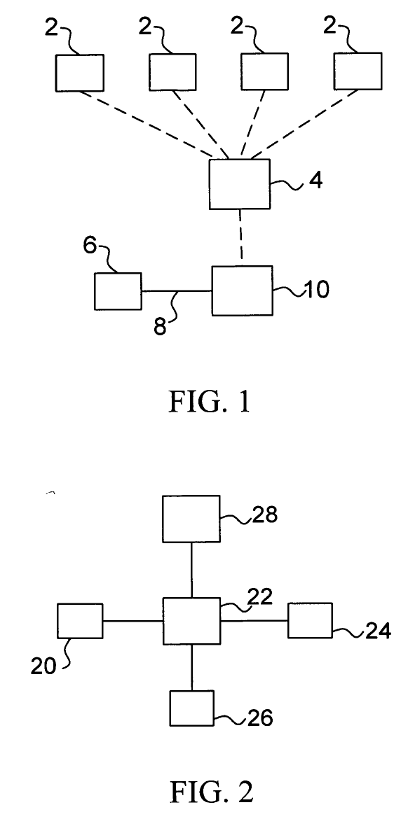

A first embodiment of the invention provides a pollution-monitoring system. The system comprises a plurality of identically-constructed monitors 2, a base station 4 and a remote computer 6 coupled over the Internet 8 to a text-messaging service 10, as illustrated in FIG. 1.

As shown in FIG. 2, each monitor comprises a sensor 20 that outputs a signal dependent on the concentration of a chemical (pollutant) detected by the sensor. The sensor output is connected to monitor processor 22, which is in turn connected to a monitor memory 24, a re-chargeable battery 26 and a Bluetooth interface 28. These components are all housed in a monitor housing 70, as illustrated in FIG. 4. An electrical connector socket 76 is mounted in the housing and coupled to the re-chargeable battery, for receiving an electrical lead to provide power for re-charging the battery under the control of the processor. A user-operable push button 72 and a light emitting diode 74 are mounted on a front surface of the housing, and are coupled to the processor.

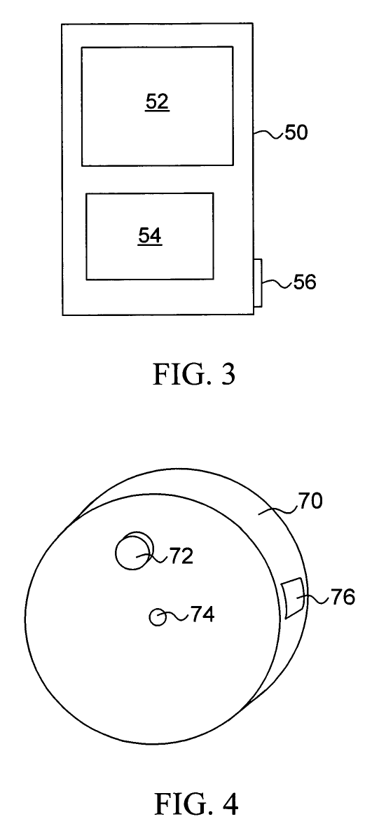

The hand-held base station 50 as illustrated in FIG. 3 is a suitably-programmed PDA comprising a display screen 52 and a user interface in the form of a keypad 54. The base station comprises, in conventional manner, a Bluetooth interface and a mobile telephone interface capable of transmitting and receiving text messages. The base station additionally comprises an electrical socket 56 which can be connected by an electrical lead to the socket 76 of the monitor in order to provide power to the monitor to re-charge its battery 26.

In alternative embodiments, the base station may take the form of a mobile telephone or a portable computer or a bespoke hand-held device, in each case having similar functionality to the PDA described above.

In a further alternative, the base station may not be used to provide power for re-charging the monitor battery. In that case, a separate re-charging unit is couplable to the monitor to provide power for re-charging the battery.

Operation of the First Embodiment

In operation, the sensor within each monitor detects a concentration of a chemical in the environment of the monitor and outputs a corresponding voltage. The voltage is amplified and filtered by the processor to capture a signal representative of the chemical concentration. The processor measures the signal at a pre-determined measurement rate, or sensor output rate, such as once per second (1 Hz) and processes the resulting samples within the processor RAM. The data can be processed in different ways. In one embodiment, the processor measures a peak value in each of a series of sampling intervals (for example every ten seconds) and sums the peak values to calculate a total value over a longer storage time or epoch length. The epoch length may be any pre-determined interval but is preferably between one and ten minutes. The total value recorded in each successive epoch is stored in the memory 24 as a chemical concentration level.

In an alternative embodiment, instead of summing peak values recorded in a series of sampling intervals, the measured sensor output voltage is integrated over each epoch length to generate a concentration level for storage in the memory. In this case the sampling interval can be equal to the epoch length. The concentration levels, or data, for each epoch are written sequentially into the memory for further processing within or without of the monitor, as described below.

A pollution-monitoring system according to the first embodiment comprises a plurality of monitors installed at different sites. These each continuously log local information which can be downloaded to a remote computer by an operator carrying a portable base station. To do so, the operator periodically visits each monitor so that a Bluetooth interface can be set up between the base station and the monitor, and the logged data from that monitor (or information derived by additional processing of the logged data) transmitted to the remote computer as described below.

Before data collection can take place, the system must therefore be set up as follows:

Each monitor requires set-up information including at least a monitor identifier (ID) and timing information such as the measurement rate, sampling rate and epoch length to be used. A user may enter this information either into the base station, using its user interface 54, or into the remote computer. In each case, the base station or the remote computer is suitably programmed to prompt the user to enter the required information. If the information is entered into the remote computer, then it is transmitted to the base station in a suitably-formatted text message. The base station is then interfaced to the monitor to download the information to the monitor. If the set-up information is entered into the base station, then the base station can be interfaced to the monitor to download the information. It may also be desired to place the information in a text message and transmit it from the base station to the remote computer so that the remote computer has a record of the monitor ID and its associated operating parameters.

An example of the formatting or encoding of set-up information in a text message is provided below.

When the monitors are installed and are logging data, the operator carrying the base station visits each monitor at predetermined times in order to set up a Bluetooth interface between the monitor and the base station, download logged data from the monitor and transmit it in a suitably-encoded text message to the remote computer. As illustrated in FIG. 4, in the embodiment, each monitor is housed within a cylindrical housing 70 and provided with a push button 72 and a light emitting diode (LED). On approaching each monitor, the operator can press the button 72 in order to activate the monitor's Bluetooth interface 28. The LED illuminates briefly to indicate that the monitor has received this user input. The Bluetooth interfaces in the monitor and the base station then connect with each other in known manner and logged data stored in the monitor memory 24 is downloaded to a memory of the base station. The monitor ID and set-up parameters can be downloaded with the logged data. For example, the monitor ID should accompany the stored data so that the base station and the remote computer can determine which monitor provided the data. It may also be desirable for the monitor set-up parameters to accompany the logged data, although this may not be necessary if the base station and the remote computer already have records of set-up information associated with each monitor ID.

Having downloaded the logged data from a monitor, the base station can transmit it in a suitably-formatted text message to the remote computer. Further details of the text-message structure are described below.

Depending on the programming of the base station and the capabilities of its user interface and display, in a preferred embodiment the user can display the logged data on the base-station display. This may be useful for immediate display and/or analysis of the logged data, or as a check that the monitor is functioning correctly.

Information downloaded from the monitor to the base station may also include an indication of the state of charge of the monitor's re-chargeable battery 26. The base station is programmed to display a warning to the user if the battery requires re-charging. If so, the user can re-charge the battery via the socket 76 in the monitor housing 70 (as shown in FIG. 4). The electrical power for re-charging may be supplied through an electrical lead either from the base station itself or from a separate re-charging unit.

While the base station is interfaced to a monitor, new set-up information may be transmitted to the monitor if desired, derived from user inputs either to the base station or to the remote computer and transmitted in a text message to the base station.

Information Transmission

As described above, in a preferred embodiment a monitor can be interfaced to a base-station, and in particular to a hand-held or portable base-station, by means of a wireless interface. Such an interface will now be described in more detail, in the context of a Bluetooth wireless link. The base-station in the embodiment is in the form of a Bluetooth-enabled PDA, which is controlled by the monitor to transmit data, in processed or unprocessed form, in a text message. The text message is sent to a text-messaging service accessible on the Internet. A user may then use a suitably-networked computer or PC (the remote computer) to retrieve the downloaded information over the Internet for further processing or display. The logged data collected by the monitor may be processed at any point in the communication chain. For example, it may be desired to process the logged data into pollution or contamination levels, and any of these calculations can be performed by the monitor or the PDA or the remote computer, if suitably programmed. In one embodiment, for example, the PDA may have sufficient functionality to provide a display to the user as soon as the data is downloaded from the monitor (which in this embodiment does not have a display), in which case any conversion of logged concentration data to, for example, contamination levels would need to be carried out by the monitor or the PDA. The processed data may then be transmitted to the remote computer. Alternatively, the basic logged data may be converted for display on the PDA as desired by the user of the PDA but the basic logged data may be transmitted to the remote computer.

The monitor is Bluetooth-enabled and in response to the user pressing the push-button on the monitor, it looks for nearby Bluetooth-enabled devices. If it detects the PDA, it sets up a Bluetooth link by pairing with it in known manner. In order to enable the pairing, the user enters a Bluetooth-device pass number into the PDA, using the conventional Bluetooth pairing procedure.

The monitor first looks for any set-up information by using the Bluetooth link to read information from the phone book of the PDA. It looks in the phone book for a name string starting with the five-letter string “Znnnn”. The initial letter “Z” is used in the name string to place the entry near or at the end of the phone book and reduce the risk of editing or erasing the entry by accident. The subsequent characters “nnnn” refer to the 4-digit monitor ID. This initial five-letter string thus identifies the correct entry for the particular monitor in the phone book. The full name string contains ten characters and the monitor (if it recognises its own monitor ID) uses the five characters following “Znnnn” for set-up information, and the telephone number stored at this location in the phone book, as described below.

The monitor is programmed to download activity data to the PDA by means of one or more text messages, and the phone number associated with the ten-character name string in the phone book is read by the monitor as the text-message address. The phone number is in international format, i.e. +44xxx . . . xx.

The ten-letter name string containing the set-up information, and the phone number, have been entered into the PDA in a previous initialisation procedure. This may involve a user entering the data into the phone book in the conventional manner or may involve operation of a suitable program running on the PDA which prompts the user to enter the set-up information and encodes it appropriately in the phone book, or creates the phone book entry in response to instructions in a text message from the remote computer.

The ten-character name string is read by the monitor and the last five characters used as follows. The first two characters (of the last five characters) define the epoch length over which concentration data are to be recorded and the final three characters define the rate for sampling the sensor output.

After the monitor has received the set-up information from the mobile phone, it uses the serial port profile of the PDA enabled by the pairing of the monitor and the PDA in order to control the PDA to transmit a text message containing any logged data, in processed or unprocessed form, collected by the monitor since a previous download.

Each text message is composed of a message header followed by data values. The message header comprises the following 12 bytes, in sequence:

TABLE 1

| | | | |
|---|---|---|---|
| SSSS | Serial number | 2 bytes | Monitor ID number |
| CC | Calibration factor | 1 byte | Sensor calibration |
| bb | Battery level | 1 byte | Battery level Volts = |
| | | | bb * 2.5/128 |
| EE | Epoch | 1 byte | Epoch length in minutes |
| DDMMYY | Start date | 3 bytes | |
| DD | Data day | 1 byte | Number of day of first data |
| | | | byte (counted from start date) |
| MMMM | Data minute | 2 bytes | Minute of first data byte |
| | | | (counted from start of day) |
| ss | Samples | 1 byte | Number of data samples |
| | | | in message |

The serial number is the monitor ID number. Transmitting this information allows the same base-station to be used with different monitors, as described above. The calibration factor allows the base-station to calculate concentration levels from the logged data recorded by the monitor. Transmitting the battery level information allows the base-station to compensate for falling battery level, which in many types of sensor affects the output of the sensor as the battery voltage drops. In an alternative embodiment, the monitor itself may be programmed to calculate concentration levels, using the calibration factor and the battery level (if required), rather than simply logging the sensor output or integrated or averaged data calculated using the sensor output. In that case the concentration levels stored by the monitor may be transmitted to the base-station and the calibration factor information omitted from the message header.

The battery level information should still be transmitted as this can be used to warn the user when the monitor battery needs recharging.

The start date, data day and data minute identify the period covered by the reporting period during which the data in the message was recorded. The number of samples defines the number of data samples to be transmitted in the remainder of the message. Each data value (sample) comprises 1 byte.

The monitor of the embodiment records data in each epoch as a 16-bit reading. The data is compressed for transmission in the text message using an algorithm to compress the 16-bit readings into 8 bits. The formula for the compression is as follows:
Vₙ=Vₙ₋₁+1+(Vₙ₋₁/32)

By way of example, if a 5 minute epoch length is set, then a reporting interval of 8 hours corresponds to 96 epochs. Data logged in this reporting interval can then be sent in a single text message.

The bytes of the message are preferably suitably encoded before transmission to the base-station; if the monitor is paired with the base station, it can directly control the mobile-telephone functionality of the base station and needs to tell it the contents of the text message to be sent.

The message format must be reliably readable by the base-station and on any further transmission. A normal text message can be up to 140 bytes (8-bit) or 160 7-bit ASCII values. The conventional message format can thus comprise either 8-bit or 7-bit characters. The 8-bit format was primarily designed for sending tones and pictures to and from mobile phones, but can lead to reception errors if sent to an incompatible unit. The 7-bit format can also cause problems as certain characters cannot be suitably encoded by all transmitting units or may not be correctly read by all receiving units, particularly if the data can include control codes.

To overcome these problems, in the embodiment the data to be sent in a text message is encoded using a 6-bit character map to generate a message in the 7-bit format but using only selected 7-bit characters which are reliably transmitted and received. This embodiment therefore uses the characters 0-9, A-Z, a-z, and ( ) to represent the 64 values required. This method allows 120 bytes of data in each message. With the 12-byte header described above, this allows 108 bytes of data in each message. Encoding and decoding can be performed using a look-up table. The 6-bit to 7-bit encoding table of the embodiment is illustrated below.

TABLE 2
6-Bit to 7-Bit Encoding Table

| Hex | ASCII |
|---|---|
| &H00 | ‘0’ |
| &H01 | ‘1’ |
| &H02 | ‘2’ |
| &H03 | ‘3’ |
| &H04 | ‘4’ |
| &H05 | ‘5’ |
| &H06 | ‘6’ |
| &H07 | ‘7’ |
| &H08 | ‘8’ |
| &H09 | ‘9’ |
| &H0A | ‘(’ |
| &H0B | ‘)’ |
| &H0C | ‘A’ |
| &H0D | ‘B’ |
| &H0E | ‘C’ |
| &H0F | ‘D’ |
| &H10 | ‘E’ |
| &H11 | ‘F’ |
| &H12 | ‘G’ |
| &H13 | ‘H’ |
| &H14 | ‘I’ |
| &H15 | ‘J’ |
| &H16 | ‘K’ |
| &H17 | ‘L’ |
| &H18 | ‘M’ |
| &H19 | ‘N’ |
| &H1A | ‘O’ |
| &H1B | ‘P’ |
| &H1C | ‘Q’ |
| &H1D | ‘R’ |
| &H1E | ‘S’ |
| &H1F | ‘T’ |
| &H20 | ‘U’ |
| &H21 | ‘V’ |
| &H22 | ‘W’ |
| &H23 | ‘X’ |
| &H24 | ‘Y’ |
| &H25 | ‘Z’ |
| &H26 | ‘a’ |
| &H27 | ‘b’ |
| &H28 | ‘c’ |
| &H29 | ‘d’ |
| &H2A | ‘e’ |
| &H2B | ‘f’ |
| &H2C | ‘g’ |
| &H2D | ‘h’ |
| &H2E | ‘i’ |
| &H2F | ‘j’ |
| &H30 | ‘k’ |
| &H31 | ‘l’ |
| &H32 | ‘m’ |
| &H33 | ‘n’ |
| &H34 | ‘o’ |
| &H35 | ‘p’ |
| &H36 | ‘q’ |
| &H37 | ‘r’ |
| &H38 | ‘s’ |
| &H39 | ‘t’ |
| &H3A | ‘u’ |
| &H3B | ‘v’ |
| &H3C | ‘w’ |
| &H3D | ‘x’ |
| &H3E | ‘y’ |
| &H3F | ‘z’ |

For example, if the three bytes 11000000 11010000 00010111 are encoded for transmission they will first be divided into 6-bit elements as (110000)(00 1101)(0000 00)(010111). These 6-bit elements are, in hexadecimal, &H30 &H0D &H00 &H17 and will be encoded using the encoding table set out above as kB0L for transmission in the text message.

This encoding procedure generates a 7-bit message using only normal text characters, which can be reliably input to a conventional text-messaging system for transmission from the monitor to the base-station and, as required, for transmission on to other units including the remote computer.

Alternative embodiments

A further embodiment provides a system comprising a medical monitor, a base station in the form of a mobile telephone and a remote computer. The medical monitor is to be worn by a user, and comprises a sensor for measuring a parameter such as the user's blood-sugar level, physical activity or heart rate, in known manner. The structure of the monitor, apart from the nature of the sensor, is as described above and illustrated in FIGS. 2 and 4.

In this embodiment, the same reporting procedure may be used as described in the earlier embodiments relating to chemical monitoring. That is, a Bluetooth interface between the monitor and the base station, in the form of the mobile telephone, may be set up when the button on the monitor is pressed by a user. Set-up information and logged data can then be exchanged between the monitor and the base station, as required, and a text message carrying any logged data transmitted to the remote computer. In the medical-monitoring embodiment this arrangement may be appropriate if, for example, the monitor is worn by a patient and the base station is carried by a medical practitioner who can download the logged data when visiting the patient. In an alternative embodiment, however, the base station may be carried by the patient; the Bluetooth interface can be conveniently set up at pre-determined times rather than on user activation of the monitor push button, because the monitor and the base station are likely to be sufficiently close to each other to set up the Bluetooth interface at those times.

In a further variation from the earlier embodiments, the monitor may have the facility for the user, or patient, to enter markers into the logged data by pressing the monitor push button. This may, for example, enable the patient to record events such as meals, which may be of value in assessing logged data relating to blood-sugar level, for example.

In a system in which the monitor seeks to download logged data to the base station at regular intervals, appropriate timing information needs to be included in the monitor set-up information, or the monitor can use a default setting.

The monitor logs a data reading at the end of each epoch, as described above, and the reporting interval is preferably defined in terms of a number of epochs, termed an epoch reporting period. In an embodiment described above, set-up information was recorded in the phone book of the base station as a 10-character string. In the present embodiment, the first five characters of this string similarly provide the initial letter “Z” followed by the 4-character monitor ID. In this embodiment, however, the last five characters are used as follows. The first two characters (of the last five characters) define the epoch length over which logged data are to be recorded and the final three characters define the epoch reporting period. The epoch length is set in minutes and the epoch reporting period as a number of epochs. Consequently, in this embodiment the epoch length can in principle be set between 1 and 99 minutes and the epoch reporting period can be set between 1 and 999 epochs. In practice, however, epoch lengths of between 1 and 15 minutes may typically be chosen, and the epoch reporting period set depending on the frequency with which downloads of data to the base station are desired. For example if a monitor is to be used to collect data over several days, a download every few hours may be satisfactory. But if a monitor is to be used to monitor a user's energy expenditure during a period of physical exercise (for example derived from activity data), much more frequent downloads may be desired. In addition, the number of epochs in each epoch reporting period may be limited by the capacity of the message used to download data at the end of each reporting period, as described below.

As an example, the ten-letter name string may read “Z000305096” which will set up the monitor with monitor ID 0003 to record activity data over 5 minute epochs and prepare a report for sending by means of a text message to the mobile phone every 96 epochs (i.e. every 8 hours).

Typically, an epoch length of 5 minutes or 15 minutes (or another period which divides into 60 minutes) might be set, in which case the monitor preferably starts logging data on the hour, each hour. That is, if a 15 minute epoch is set, the monitor preferably logs data at, say, 08:15, 08:30, 08:45, 09:00 etc.

Alternatively, or in addition to the regular reporting periods described above, the monitor may attempt to set up a Bluetooth link and send data to the base station at a pre-determined time each day, such as a midnight. This would additionally permit the monitor to synchronise its clock with the base station at regular intervals.

In this embodiment, the text message structure described for earlier embodiments needs to be modified to accommodate the transmission of markers as described above. This first requires the use of a 13-byte message header, comprising the 12 bytes previously described followed by a single byte “mm” indicating the number of markers recorded in the text message.

Each 16-bit (2 byte) marker value is recorded by the monitor in terms of the day on which the marker was recorded (by the user pressing the monitor push button), counting the days from the start of the recorded data, and the minute of the day in which the marker was recorded. Thus, the 16-bit marker value consists of 5 bits of day information and 11 bits of minute information. This can be illustrated as:

dddd dmmm mmmm mmmm

The monitor in the embodiment can store up to 256 markers and they are transmitted in the text messages sent by the monitor in any available space left after sending the activity data. This puts a limit on the number of markers that can be transmitted in each reporting period, depending on the number of epochs in each reporting period. The maximum length of a text message in the embodiment, as described above, is 120 bytes. Thus, if the epoch reporting period is set to 96 epochs, each text message must contain 96 bytes of activity data. The message header in the present embodiment contains 13 bytes, leaving 11 bytes for marker values. This provides room for 5 markers in each reporting period.

If a five minute epoch length is set and a message is transmitted every 96 epochs, the reporting interval is eight hours. This allows 5 marker values in each 8-hour period. Any missed markers may be reported at the end of the subsequent epoch reporting periods, which allows 15 markers each day. If this is inadequate, then the problem can be overcome by reducing the epoch reporting period to, say, 72 epochs. This then allows 17 markers in each reporting message.

Other Aspects

In a further variation to the embodiments described above, the system may make use of an in-box facility at the base station, as conventionally provided on devices with mobile telephone capability. Thus, when a download of information from the monitor to the base station is required, either at a pre-determined time or on pressing a button on the monitor, the monitor creates a text message and sends it on the Bluetooth link to the in-box of the base station. From there, the base station can transmit the text message to the remote computer.

A similar approach can be used in reverse to provide set-up information to the monitor. A text message can be placed in the “unsent items” portion of the base station's mail box and the monitor suitably programmed so that, when the monitor pairs with the base station, it can find the text message and transfer the set-up information to its own memory.

In a preferred embodiment, the following pairing routine may be programmed into the monitor in order to improve the flexibility of the system, so that the monitor can pair with a base station programmed according to any of the embodiments:
1. On pairing, the monitor looks in the base station's phone book for an entry identified as, for example, “Znnnn”. If it finds such an entry, it reads the associated set-up information.
2. If no such entry is found in the phone book, the monitor looks in the unsent items store in the base station for a text message addressed to that monitor. If it finds such an entry, it reads the set-up information in the text message.
3. If the monitor still finds no set-up information, then it either retains its existing set-up status or sets default values, previously stored in the monitor, for further operation.
4. The monitor sends an acknowledgement message to the base station to indicate whether or not it has found any set-up information and to confirm that set-up is complete.
5. The monitor downloads any logged data to the base station as described in earlier embodiments.

As envisaged in this embodiment, a monitor may be able to exchange information with more than one base station, including differently-programmed base stations. In a further alternative embodiment, the monitor (which in this embodiment is Bluetooth-enabled) may be programmed such that when it detects a nearby Bluetooth-enabled device it can determine whether the device is a mobile phone with only the capability to transmit a text message containing data downloaded from the monitor, or is a more sophisticated base-station incorporating, for example, the ability to process and display logged data. In the latter case, the monitor may not need to format or encode the logged data into a form suitable for transmission in a text message, using the encoding procedure described above. Instead, it may simply download the logged data itself to the base-station, knowing that the base-station in the embodiment is suitably programmed to encode the data itself for transmission in a text message.

In a further variation, the base-station may be secured to an exercise machine, such as a treadmill, and may display data downloaded from the monitor to the base station over a wireless link, such as a Bluetooth link. A user exercising on the exercise machine may then be able to see, for example, energy-expenditure data substantially in real time, displayed on the base-station display. In this case, a short epoch length, such as 30 seconds, and a short epoch reporting period, such as one or two epochs, may be set so that the displayed information is regularly updated. In addition, if the base-station comprises mobile phone functionality, the data can be formatted as a text message and transmitted to a text messaging service for later viewing on a remote computer by the user.

In order to enable the processing of data for display, it may desirable for the processing and display device (usually either the base station or the remote computer) to have certain additional information. For example, if energy-expenditure data is to be calculated, as described above, in addition to activity data it is desirable to have information such as the user's height, weight, and age. If the base station is to be used as a display device, it should then have this information. If the same base station is always used with a particular monitor, then this information can be stored by the base station in association with the monitor ID. If, however, different base stations may be used, then this information may be stored in the monitor and downloaded with logged data from the monitor to the base station. The base station then may effectively be used as a local display device for the monitor, in addition to providing the capability to transmit logged data conveniently to a remote computer for further analysis.

Although the apparatus and method described above for wireless transmission of data has been described with reference to certain types of monitor, the same techniques may be applied to transmit data from any monitoring device to a remote computer for convenient analysis and display.

In the foregoing description, a very simple monitor structure has been described. Embodiments of the invention may, however, be applicable to more complex monitors incorporating, for example, user interfaces and displays.

All patents, patent applications including British priority application No. 0516470.2, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A method for transmitting information between a monitor and a remote computer, the monitor comprising a sensor coupled to a memory for logging data output by the sensor over time, comprising the steps of;
interfacing the monitor to a base station for transmitting the information between the monitor and the base station; and
transmitting the information between the base station and the remote computer by means of a text message.

2. The method according to claim 1, in which the monitor is interfaced to the base station by means of a wireless interface.

3. The method according to claim 1, in which the base station is a portable or hand-held base station, such as a mobile telephone or a PDA (personal digital assistant) or a portable computer with mobile telephone functionality.

4. The method according to claim 1, in which the remote computer is coupled to a network, such as the Internet, in order to receive or transmit the text message.

5. The method according to claim 1, in which the information for transmission comprises data logged by the monitor, in processed or unprocessed form.

6. The method according to claim 5, in which the monitor reads a telephone number for addressing the text message from a memory of the base station or a memory of the monitor, controls the creation of the text message incorporating the information for transmission, and controls the base station to transmit the text message, the telephone number for addressing the text message preferably being stored at a predetermined location in a telephone book of the base station.

7. The method according to claim 5, in which the information is downloaded from the monitor to the base station and the base station controls the creation of the text message incorporating the information for transmission, reads a telephone number for addressing the text message from a memory of the base station or a memory of the monitor, and transmits the text message;
and/or in which an attempt is made to transmit the text message at a predetermined time or at predetermined time intervals or in response to a feature of the data output by the sensor;
and/or in which an attempt is made to transmit the text message in response to a user input to the monitor or to the base station.

8. The method according to claim 1, in which the text message comprises a message header followed by the information for transmission, the message preferably being encoded using a 6-bit character map to generate a message in 7-bit format using a subset of a 7-bit character set;
in which the subset of the 7-bit character set optionally comprises only text characters and/or does not include control characters.

9. The method according to claim 8, in which the header comprises information identifying the monitor, and/or in which the monitor is powered by a battery and the header comprises information indicating the state of charge of the battery.

10. The method according to claim 1, in which the base station comprises a display and the method includes the step of displaying data logged by the monitor, in processed or unprocessed form, on the display.

11. The method according to claim 1, including the step of interfacing the base station to the monitor for transmitting information to the monitor;
in which the information transmitted to the monitor optionally includes monitor set-up information;
and/or in which the base station optionally comprises a user interface and the information for transmission to the monitor includes information input by a user to the base station by means of the user interface;
and/or in which the information for transmission to the monitor optionally includes information received by the base station in a text message from the remote computer;
and/or in which the information for transmission to the monitor is optionally stored at a predetermined address in a telephone book of the base station before transmission of the information to the monitor;
and/or in which the information for transmission to the monitor is optionally stored in a mailbox of the base station before transmission of the information to the monitor.

12. A communications system comprising a monitor, a base station and a remote computer, in which;
the monitor comprises a sensor coupled to a monitor memory for logging data output by the sensor over time, and a monitor interface coupled to the memory;
the base station comprises a first base-station interface for communication with the monitor interface, and a second base-station interface, the second interface being a text-messaging interface; and
the remote computer comprises or is coupled to a computer interface, the computer interface being a text-messaging interface for communication with the second base-station interface.

13. The communications system according to claim 12, in which the monitor interface and the first base-station interface form a wireless interface.

14. The communications system according to claim 12, in which the base station is a portable or hand-held base station.

15. The communications system according to claim 12, in which the remote computer is coupled through a network, such as the Internet, to the computer text-messaging interface.

16. The communications system according to claim 12, in which the monitor can create a text message for transmission to the remote computer, and control the base station to send the text message.

17. The communications system according to claim 12, in which the base station can download information from the monitor for transmission to the remote computer, create the text message and transmit it to the remote computer.

18. The communications system according to claim 12, in which the information for transmission to the remote computer comprises data logged by the monitor, in processed or unprocessed form.

19. The communications system according to claim 12, in which the monitor comprises a user-operable control and, on activation of the control by a user, the monitor attempts to cause a text message to be transmitted to the remote computer.

20. The communications system according to claim 12, in which the base station comprises a display on which data logged by the monitor, in processed or unprocessed form, can be displayed.

21. The communications system according to claim 12, in which the text message comprises a message header followed by information for transmission.

22. The communications system according to claim 12, in which the text message is encoded using a 6-bit character map to generate a message in 7-bit format using a subset of a 7-bit character set;
in which the subset of the 7-bit character set optionally comprises only text characters and/or does not include control characters.

23. The communications system according to claim 21, in which the header comprises information identifying the monitor;
and/or in which the monitor is powered by a battery and the header comprises information indicating the state of charge of the battery.

24. The communications system according to claim 12, in which the base station can interface to the monitor for transmitting information to the monitor;
in which the information transmitted to the monitor optionally includes monitor set-up information;
and/or in which the base station optionally comprises a user interface and the information for transmission to the monitor includes information input by a user to the base station by means of the user interface;
and/or in which the information for transmission to the monitor optionally includes information received by the base station in a text message from the remote computer.

25. The monitor for use in a communications system as defined in claim 12.

26. The base station for use in a communications system as defined in claim 12.

27. The remote computer for use in a communications system as defined in claim 12.

28. A method for encoding information for transmission in a text message, comprising the step of using a 6-bit character map to generate a message in 7-bit format using a subset of a 7-bit character set;
in which the subset of the 7-bit character set optionally comprises only text characters and/or the subset of the 7-bit character set optionally does not include control characters.

29. A computer program for programming a mobile telephone, a personal digital assistant (PDA) or a computer to implement the functionality of a base station for use in a method as defined in claim 1.

30. The computer program according to claim 29, wherein said base station is for use in an apparatus as defined in claim 12.
